(19) United States
(12) Patent Application Publication
(10) Pub. No.: US 2011/0295458 A1
(43) Pub. Date: Dec. 1, 2011

(54) Systems and Methods for Selectively Disabling One or More Features of a Mobile Access Device and/or a Vehicle Associated with the Mobile Access Device

(75) Inventor: Nicole Ma Ellen Halsey-Fenderson, Roanoke, VA (US)

(73) Assignee: VERIZON VIRGINIA, Richmond, VA (US)

(21) Appl. No.: 12/789,624

(22) Filed: May 28, 2010

(51) Int. Cl. B60R 21/00; G01S 19/42; H04W 4/00; H04W 4/14; G10L 15/26; G06F 7/00; H04B 7/00

(52) U.S. Cl. 701/29; 701/1; 455/41.2; 455/466; 704/235; 455/569.1; 704/E15.043

(57) ABSTRACT

An exemplary method includes a vehicle operation safety system detecting an operating parameter of a vehicle, detecting that a mobile access device is located within a predefined vicinity of the vehicle, and disabling one or more features of the mobile access device in response to the detecting of the operating parameter of the vehicle and the detecting that the mobile access device is located within the predefined vicinity of the vehicle. Corresponding methods and systems are also disclosed.

### BACKGROUND INFORMATION

Mobile phones and other mobile access devices have enjoyed increasingly widespread use over the years. The capabilities of mobile access devices have also increased, allowing their users to make phone calls, send and receive text messages and emails, surf the web, view movies, listen to music, and much more.

Despite their benefits, mobile access devices pose a hazard when used while operating a vehicle (e.g., an automobile). For example, users attempting to use a mobile access device (e.g., to send a text message) while operating a motor vehicle are at a significant risk of causing an accident that could harm themselves and others. The associated risks increase with the increased usage of mobile access devices by vehicle operators. Accordingly, there are a number of disadvantages that exist with respect to the concurrent usage of mobile access devices and vehicles.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical reference numbers may designate identical or similar elements.

FIG. 1 illustrates an exemplary vehicle operation safety system according to principles described herein.

FIG. 2 illustrates an exemplary implementation of the exemplary vehicle operation safety system of FIG. 1 according to principles described herein.

FIG. 3 illustrates an exemplary vehicle operation safety method according to principles described herein.

FIG. 4 illustrates an exemplary detection that a mobile access device is within a predefined vicinity of a vehicle according to principles described herein.

FIG. 5 illustrates an exemplary docking of a mobile access device into a docking station according to principles described herein.

FIG. 6 illustrates another exemplary implementation of the exemplary vehicle operation safety system of FIG. 1 according to principles described herein.

FIG. 7 illustrates another exemplary vehicle operation safety method according to principles described herein.

FIG. 8 illustrates an exemplary computing device according to principles described herein.

### DETAILED DESCRIPTION OF PREFERRED EMBODIMENTS

Exemplary systems and methods for selectively disabling one or more features of a mobile access device and/or a vehicle associated with the mobile access device are disclosed herein. As described further below, one or more of the exemplary systems and/or methods disclosed herein may help a vehicle operator to operate a vehicle without concurrently and unsafely utilizing a mobile access device (e.g., to send/read text messages, to surf the web, to make phone calls, etc.). For example, the exemplary systems and/or methods disclosed herein may selectively disable one or more features of a mobile access device or a vehicle to prevent unsafe usage of the mobile access device while the vehicle is in operation.

As an example, a vehicle operation safety system may be configured to detect an operating parameter of a vehicle, detect that a mobile access device is located within a predefined vicinity of the vehicle, and disable one or more features of the mobile access device in response to the detection of the operating parameter of the vehicle and the detection that the mobile access device is located within the predefined vicinity of the vehicle. In this or a similar manner, the methods and/or systems described herein may promote safe operation of vehicles and usage of mobile access devices.

As used herein, a “mobile access device” may refer to any electronic device used for mobile communications (e.g., mobile telecommunications, text messaging, mobile data transmission, etc.). For example, a “mobile access device” may include, but is not limited to, a mobile phone, a smartphone, a personal digital assistant (“FDA”), a hand-held gaming console (e.g., a Nintendo DS or the like), a portable media player (e.g., an iPod or the like), an ultra-mobile PC, a tablet PC (e.g., an iPad or the like), and/or any other suitable mobile device.

As used herein, a “vehicle” may refer to any mechanical means of transportation. For example, a “vehicle” may include an automobile, a truck, a bus, a train, a boat, an aircraft, a motorcycle, and/or any other suitable vehicle.

Components and functions of exemplary vehicle operation safety systems and methods will now be described with reference to the drawings.

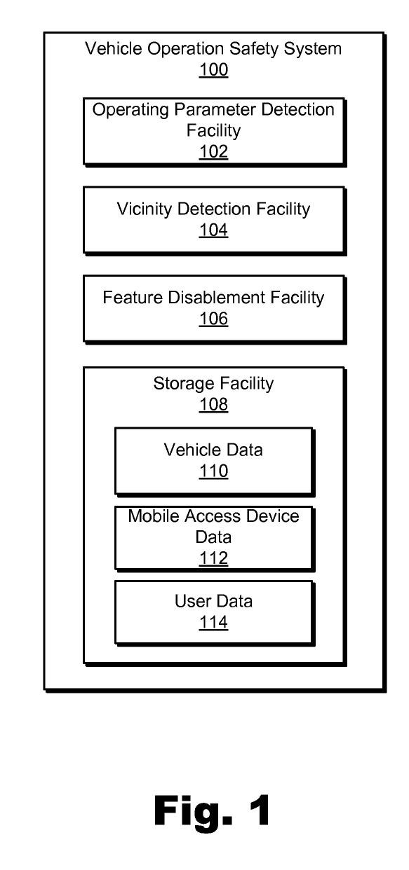

FIG. 1 illustrates an exemplary vehicle operation safety system 100 (or simply “system 100”) configured to perform one or more of the processes described herein. As shown in FIG. 1, system 100 may include an operating parameter detection facility 102, a vicinity detection facility 104, a feature disablement facility 106, and a storage facility 108, which may be in communication with one another using any suitable communication technologies.

Operating parameter detection facility 102 may be configured to detect one or more operating parameters of a vehicle. In some examples, operating parameter detection facility 102 may be configured to detect one or more parameters associated with a transmission of the vehicle. For example, operating parameter detection facility 102 may be configured to detect when a transmission of the vehicle is in gear (e.g., in “drive”). Additionally or alternatively, operating parameter detection facility 102 may be configured to detect any other operating parameter of a vehicle (e.g., a movement of the vehicle, a parameter associated with the ignition of the vehicle, a parameter associated with the parking brake of the vehicle, etc).

Vicinity detection facility 104 may be configured to detect that a mobile access device is located within a predefined vicinity of a vehicle. For example, vicinity detection facility 104 may be configured to detect that a mobile phone associated with an operator of a vehicle is physically located within the vehicle and/or within a predefined distance of the vehicle. Exemplary heuristics that may be used to detect whether a mobile access device is located within a predefined vicinity of a vehicle will be described in more detail below.

Feature disablement facility 106 may be configured to disable one or more features of a mobile access device and/or a vehicle. For example, feature disablement facility 106 may be configured to disable one or more features of a mobile access device in response to a detection of an operating parameter of a vehicle and a detection that the mobile access device is located within a predefined vicinity of the vehicle. Exemplary features of a mobile access device that may be disabled include, but are not limited to, a text-messaging feature, a calling feature, an Internet access feature, and/or any other operational feature of the mobile access device as may serve a particular implementation.

In additional or alternative examples, feature disablement facility 106 may be configured to re-enable at least one of the one or more disabled features of the mobile access device in response to a detected event or condition. For example, feature disablement facility 106 may be configured to re-enable a text-messaging or a calling feature of a mobile access device in response to an enabling of a hands-free feature (e.g., a hands-free texting feature and/or a hands-free calling feature) of the mobile access device.

Additionally or alternatively, feature disablement facility 106 may be configured to disable one or more features (e.g., operational features) of a vehicle in response to the detection that a mobile access device is located within a predefined vicinity of the vehicle. In some examples, feature disablement facility 106 may be configured to re-enable at least one of the one or more disabled features of the vehicle in response to a detection of an establishment of a physical communication link between the mobile access device and the vehicle, as will be explained in more detail herein.

Feature disablement facility 106 may be configured to disable one or more features of a mobile access device and/or a vehicle in any suitable manner as may serve a particular implementation. For example, feature disablement facility 106 may block or scramble one or more communication signals transmitted by or to the mobile access device and/or the vehicle, disable a power supply associated with the mobile access device and/or the vehicle, and/or otherwise control an operation of the mobile access device and/or the vehicle. In some examples, the one or more features may be disabled by a service provider (e.g., a wireless communications service provider) or a vehicle security service provider (e.g., OnStar).

Storage facility 108 may be configured to maintain vehicle data 110, mobile access device data 112, and/or user data 114. Vehicle data 110 may include data representative of a vehicle including vehicle identification data, vehicle location data, vehicle operator data, and/or any other information associated with the vehicle. Mobile access device data 112 may include data representative of a mobile access device including mobile access device identification data, mobile access device location data, mobile access device feature data, mobile access device user data, and/or any other information associated with the mobile access device. User data 114 may include data representative of one or more users, such as data associating a user with a particular mobile access device and/or vehicle, user profile data, and/or any other data associated with a user as may serve a particular implementation. Storage facility 108 may be configured to maintain additional or alternative data as may serve a particular implementation.

Each of the components of system 100 may implemented by or within a vehicle (e.g., a vehicular computing device included within the vehicle), a mobile access device, and/or a server configured to perform one or more of the processes described herein.

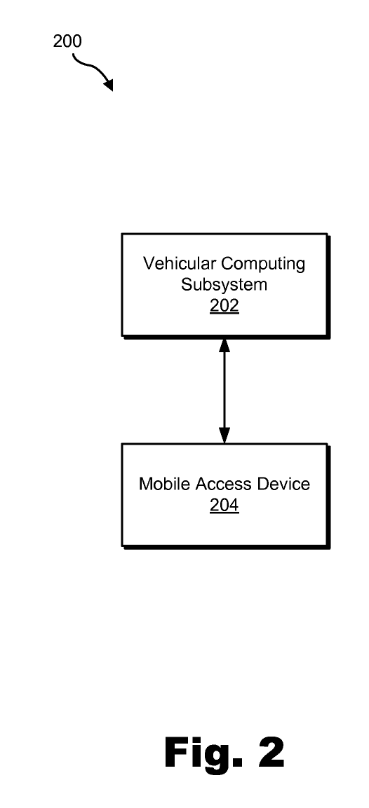

FIG. 2 illustrates an exemplary implementation 200 of system 100 wherein a vehicular computing subsystem 202 is communicatively coupled to a mobile access device 204. As will be described in more detail below, operating parameter detection facility 102, vicinity detection facility 104, feature disablement facility 106, and storage facility 108 may each be implemented on one or both of vehicular computing subsystem 202 and mobile access device 204.

Vehicular computing subsystem 202 and mobile access device 204 may be configured to communicate with one another using any suitable communication technologies, devices, media, and protocols supportive of data communications, including, but not limited to, socket connections, Ethernet, data bus technologies, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Evolution Data Optimized Protocol (“EVDO”), Time Division Multiple Access (“TDMA”) technologies, Short Message Service (“SMS”), Multimedia Message Service (“MMS”), radio frequency (“RF”) signaling technologies, wireless communication technologies (e.g., Bluetooth, Wi-Fi, etc.), in-band and out-of-band signaling technologies, and other suitable communications technologies.

In some examples, vehicular computing subsystem 202 and mobile access device 204 may be configured to communicate with each other over one or more networks. The one or more networks may include one or more networks or types of networks capable of carrying communications and/or data signals between the components of system 100. For example, the one or more networks may include, but are not limited to, a satellite network, a wireless network (e.g., a Wi-Fi and/or mobile telephone network), a Bluetooth network, the Internet, an intranet, a local area network, any other suitable network, and/or any combination or sub-combination of these networks. Additionally or alternatively, vehicular computing subsystem 202 and mobile access device 204 may be configured to communicate one with another in any other suitable manner (e.g., via a direct connection).

Vehicular computing subsystem 202 and mobile access device 204 may each be configured to perform one or more of the processes or steps described herein. To illustrate, vehicular computing subsystem 202 may be associated with a vehicle (e.g., implemented by a computing device included within or associated with the vehicle), and both the vehicle and mobile access device 204 may be associated with (e.g., used by) a particular user. In some examples, vehicular computing subsystem 202 may be configured to detect an operating parameter of the vehicle, mobile access device 204 and/or vehicular computing subsystem 202 may be configured to detect that mobile access device 204 is located within a predefined vicinity of the vehicle, and mobile access device 204 and/or vehicular computing subsystem 202 may be configured to disable one or more features of mobile access device 204 in response to the detection of the operating parameter of the vehicle and the detection that mobile access device 204 is located within the predefined vicinity of the vehicle. Accordingly, vehicular computing subsystem 202 and/or mobile access device 204 may be configured to prevent the particular user from concurrently using the vehicle and mobile access device 204 in an unsafe manner.

Implementation 200 is provided for illustrative purposes only. In additional or alternative examples, system 100 may include additional components or exclude components as may serve a particular implementation.

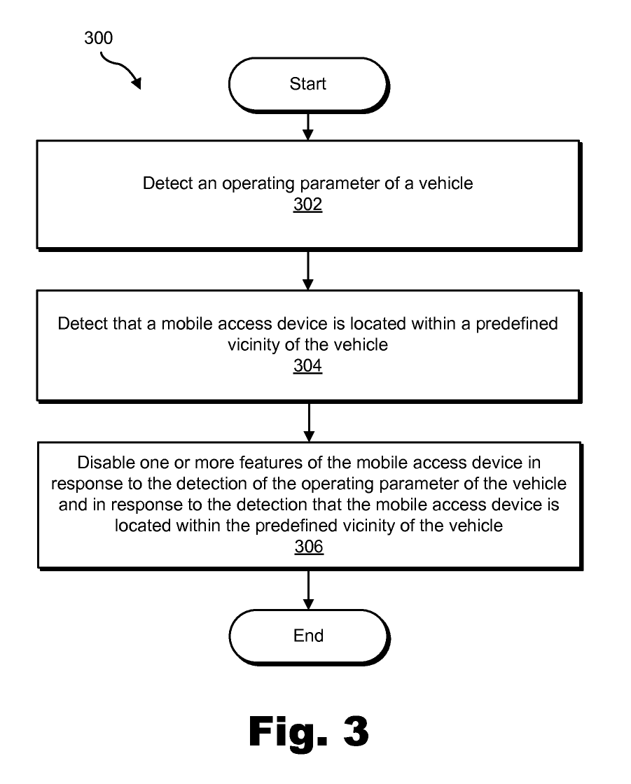

FIG. 3 illustrates an exemplary vehicle operation safety method 300. While FIG. 3 illustrates exemplary steps according to one embodiment, other embodiments may omit, add to, reorder, and/or modify any of the steps shown in FIG. 3. One or more of the steps shown in FIG. 3 may be performed by any component or combination of components of system 100.

In step 302, an operating parameter of a vehicle is detected. The operating parameter of the vehicle may be detected in any suitable manner. For example, operating parameter detection facility 102 may be configured to detect a movement of the vehicle (e.g., by detecting a speedometer reading of the vehicle), a transmission position of the vehicle (e.g., drive, park, neutral, etc.), an ignition position of the vehicle (e.g., off, on, start, accessory, etc.), a parking brake position (e.g., on or off), and/or any other suitable operating parameter of a vehicle.

In step 304, system 100 (e.g., vicinity detection facility 104) detects that a mobile access device is located within a predefined vicinity of the vehicle. The location of the mobile access device in relation to the predefined vicinity of the vehicle may be detected in any suitable manner as may serve a particular implementation.

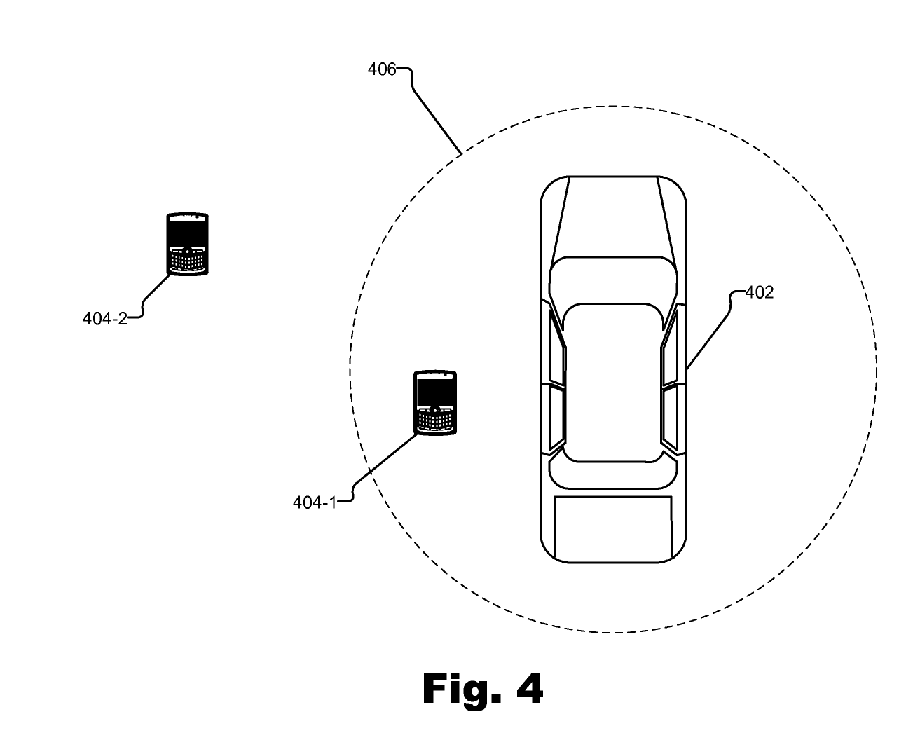

To illustrate, FIG. 4 shows a vehicle 402, mobile access devices 404-1 and 404-2 (collectively referred to herein as “mobile access devices 404”), and a predefined vicinity 406 associated with vehicle 402. Vicinity detection facility 104 (which may be implemented by mobile access devices 404 and/or vehicle 402) may detect that mobile access device 404-1 is located within predefined vicinity 406 of vehicle 402 and that mobile access device 404-2 is not located within predefined vicinity 406. Hence, feature disablement facility 106 may disable one or more features of mobile access device 404-1, but not mobile access device 404-2, in response to a detection of an operating parameter of vehicle 402.

To illustrate, a user of mobile access device 404-1 may be initially located outside of predefined vicinity 406. Mobile access device 404-1 may be carried by the user and therefore located outside of predefined vicinity 406 as well. The user may decide to utilize vehicle 402 to travel somewhere. Accordingly, the user—and, as a result, mobile access device 404-1—may move towards vehicle 402 (e.g., with the intent of operating vehicle 402). Once the user is located within predefined vicinity 406 of vehicle 402, vicinity detection facility 104 may detect that mobile access device 404-1 is located within predefined vicinity 406. One or more features (e.g., text messaging and/or calling features) of mobile access device 404-1 may be disabled in response to the detection that mobile access device 404-1 is within predefined vicinity 406 to ensure safe operation of vehicle 402 by the user (e.g., to prevent the user from concurrently operating vehicle 402 and utilizing the disabled features of mobile access device 404-1).

The boundaries of predefined vicinity 406 may include any suitable area as may serve a particular implementation. For example, as shown in FIG. 4, the predefined vicinity 406 may include a circle having a radius that is a predetermined distance from the vehicle 402. Additionally or alternatively, the predefined vicinity 406 may be defined to only include the area occupied by vehicle 402 (e.g., such that only objects within vehicle 402 are located within predefined vicinity 406). In some examples, predefined vicinity may be defined by the area within which mobile access devices 404 may communicate directly with vehicle 402 (e.g., by way of a Bluetooth connection). In additional or alternative examples, predefined vicinity 406 may only encompass mobile access devices that are coupled to vehicle 402 by way of a physical communication link (e.g., a mobile access device that is physically docked within a docking station located within vehicle 402). Other boundaries for predefined vicinity 406 may be defined as may serve a particular implementation.

Vicinity detection facility 104 may be configured to detect that mobile access device 404-1 is located within predefined vicinity 406 in any suitable manner as may serve a particular implementation. For example, vicinity detection facility 104 may detect a transmission of communication signals (e.g., Bluetooth signals) between mobile access device 404-1 and vehicle 402. In additional or alternative examples, vicinity detection facility 104 may be configured to detect the physical locations of mobile access device 404-1 and vehicle 402 and determine whether the physical location of mobile access device 404-1 is located within predefined vicinity 406 of the physical location of vehicle 402. The detection of the physical locations of mobile access device 404-1 and/or vehicle 402 may be facilitated by Global Positioning System (“GPS”) or other location detection technologies.

In some examples wherein vicinity detection facility 104 is implemented by mobile access device 404-1, mobile access device 404-1 may be configured to store the physical location of vehicle 402 and detect when mobile access device 404-1 is located within predefined vicinity 406 by comparing the stored physical location to a current location of mobile access device 404-1. To illustrate, a user of mobile access device 404-1 may travel in vehicle 402 to a particular location and then leave vehicle 402 (e.g., parked in a parking lot) and travel by foot with mobile access device 404-1 out of predefined vicinity 406. Mobile access device 404-1 may be configured to store data representative of the physical location of vehicle 402 when vehicle 402 stops and/or data representative of the physical location of mobile access device 404-1 when mobile access device 404-1 leaves predefined vicinity 406. Thereafter, mobile access device 404-1 may be configured to detect (e.g., by way of GPS technology) when mobile access device 404-1 is once again located within predefined vicinity 406 (e.g., when the user returns to vehicle 402).

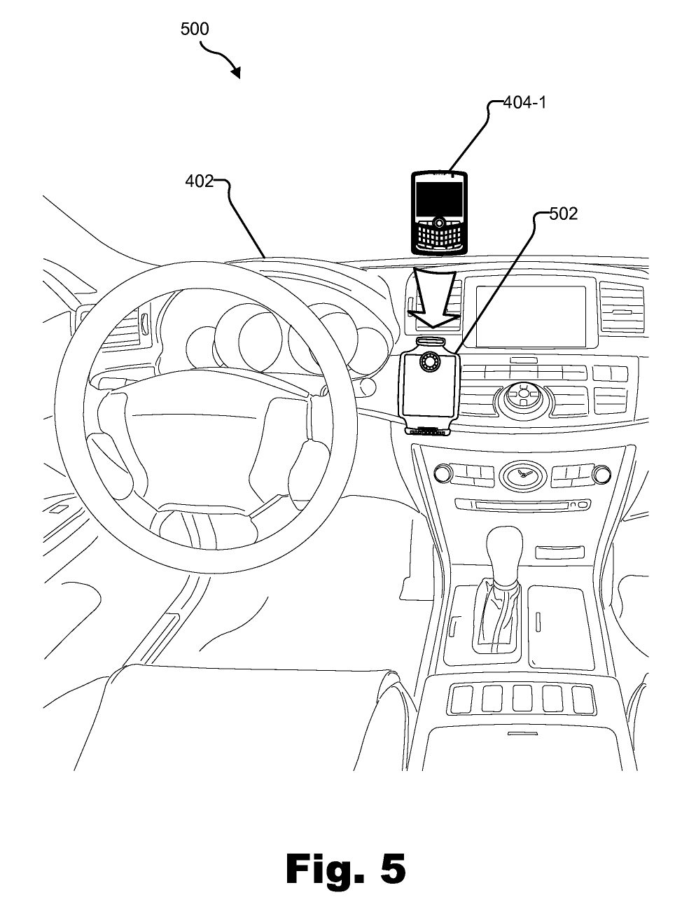

In alternative or additional examples, vicinity detection facility 104 may be configured to determine that a mobile access device is located within the predefined vicinity by detecting a physical communication link between the mobile access device and the vehicle. For example, FIG. 5 illustrates an interior 500 of a vehicle (e.g., vehicle 402) that includes a docking station 502 physically and communicatively coupled to the vehicle (e.g., electronics within the vehicle) and configured to communicatively receive a mobile access device (e.g., mobile access device 404-1). Docking station 502 may be configured to provide a physical communication link between vehicle 402 and mobile access device 404-1. In some examples, vicinity detection facility 104 may detect that mobile access device 404-1 is located within predefined vicinity 406 of vehicle 402 by detecting a docking of mobile access device 404-1 into docking station 502.

In additional or alternative examples, docking station 502 may be configured to hold mobile access device 404-1 in a convenient location and may enable one or more features of mobile access device 404-1. For example, in response to the docking of mobile access device 404-1 into docking station 502, one or more features of mobile access device 404-1 (e.g., one or more hands-free features of mobile access device 404-1) and/or vehicle 402 (e.g., one or more operational features of vehicle 402) may be enabled, as will be explained in more detail below.

Returning to FIG. 3, in step 306, one or more features of the mobile access device may be disabled in response to the detection of the operating parameter of the vehicle and in response to the detection that the mobile access device is located within the predefined vicinity of the vehicle. For example, in response to the detection of the operating parameter of the vehicle and the detection that the mobile access device is located within the predefined vicinity of the vehicle, feature disablement facility 106 may be configured to disable one or more features of the mobile access device.

Feature disablement facility 106 may be configured to disable any suitable features of the mobile access device in any suitable manner. For example, feature disablement facility 106 may be configured to disable a calling feature, an Internet access features, and/or a text-messaging feature of the mobile access device. By so doing, feature disablement facility 106 may prevent a user from unsafely making phone calls, surfing the web, and/or sending/receiving text messages while concurrently operating a vehicle.

In some examples, feature disablement facility 106 may be configured to only partially disable some features. For example, feature disablement facility 106 may be configured to disable a general calling feature of a mobile access device but not an emergency calling feature (e.g., a “911” calling feature) of the mobile access device to ensure that the user can still make certain calls in the event of an emergency.

In some examples, feature disablement facility 106 may be configured to generate and provide automated responses to incoming text messages and/or phone calls while the one or more features of the mobile access device are disabled. For example, feature disablement facility 106 may be configured to detect an incoming text message to the mobile access device when a text-messaging feature of the mobile access device is disabled. In response to detecting the incoming text message, feature disablement facility 106 may be configured to send an automated response to the sender of the text message to inform the sender that the user of the mobile access device is currently unavailable (e.g., because the user is operating a vehicle). Additionally or alternatively, feature disablement facility 106 may be configured to detect an incoming phone call and provide an automated response (e.g., an audio recording) to the caller informing the caller that the user of the mobile access device is operating a vehicle and therefore unavailable. Feature disablement facility 106 may be configured to provide any other suitable automated responses in any suitable manner as may serve a particular implementation.

Feature disablement facility 106 may be further configured to detect an enabling of a hands-free feature of a mobile access device and re-enable at least one of the one or more disabled features of the mobile access device in response to the detection of the enabling of the hands-free feature. For example, feature disablement facility 106 may be configured to detect an enabling of a hands-free calling feature of the mobile access device and re-enable a disabled calling feature of the mobile access device in response to the detection of the enabling of the hands-free calling feature. In some examples, detecting the enabling of the hands-free calling feature may comprise detecting a docking of the mobile access device in a docking station (e.g., docking station 502) associated with a vehicle and configured to enable the hands-free calling feature of the mobile access device. Additionally or alternatively, feature disablement facility 106 may be configured to detect an enabling of a hands-free text messaging feature (e.g., a text-to-speech feature and/or a speech-to-text feature) of a mobile access device and re-enable a disabled text-messaging feature of the mobile access device in response to the detection of the enabling of the hands-free text messaging feature. Feature disablement facility 106 may be configured to re-enable any other disabled feature(s) as may be suitable for a particular implementation.

In some examples, feature disablement facility 106 may be configured to disable one or more features of a vehicle in response to a detection that a mobile access device is located within a predefined vicinity of the vehicle. For example, feature disablement facility 106 may be configured to disable an operational feature of the vehicle to prevent operation of the vehicle by a user. To illustrate, as shown in FIG. 4, in response to a detection that mobile access device 404-1 is located within predefined vicinity 406 of vehicle 402, feature disablement facility 106 may disable an ignition of vehicle 402 to prevent a user from starting vehicle 402. In additional or alternative examples, feature disablement facility 106 may be configured to disable any suitable feature of vehicle 402.

In some examples, feature disablement facility 106 may be configured to re-enable one or more disabled features of the vehicle in response to an establishment of a physical communication link between the mobile access device and the vehicle. To illustrate, feature disablement facility 106 may be configured to re-enable the ignition of vehicle 402 in response to a detection of a docking of mobile access device 404-1 into docking station 502. As mentioned above, docking mobile access device 404-1 into docking station 502 may enable a hands-free calling feature associated with mobile access device 404-1. Accordingly, feature disablement facility 106 may ensure that a user does not begin operating vehicle 402 without first enabling one or more hands-free features of mobile access device 404-1, thereby ensuring safe operation of vehicle 402 without the distractions of hands-on usage of mobile access device 404-1. In additional or alternative examples, feature disablement facility 106 may be configured to re-enable any suitable feature of vehicle 402 in response to an establishment of any suitable communication link between vehicle 402 and mobile access device 404-1.

In some examples, vicinity detection facility 104 and/or feature disablement facility 106 may be configured to distinguish between a mobile access device that is associated with an operator (e.g., a driver) of a vehicle and a passenger of the vehicle. In this manner, only those features of the mobile access device associated with the operator may be disabled during operation of the vehicle, thereby allowing the passenger to use his or her mobile access device during operation of the vehicle.

Vicinity detection facility 104 and/or feature disablement facility 106 may distinguish between mobile access devices in any suitable manner. For example, vicinity detection facility 104 and/or feature disablement facility 106 may detect that a particular mobile access device is associated with an operator of a vehicle in accordance with a predefined association between the user, the vehicle, and the mobile access device. To illustrate, a parent may program vehicular computing subsystem 202 to recognize a particular mobile access device as being associated with a user (e.g., teenager) who typically operates the vehicle.

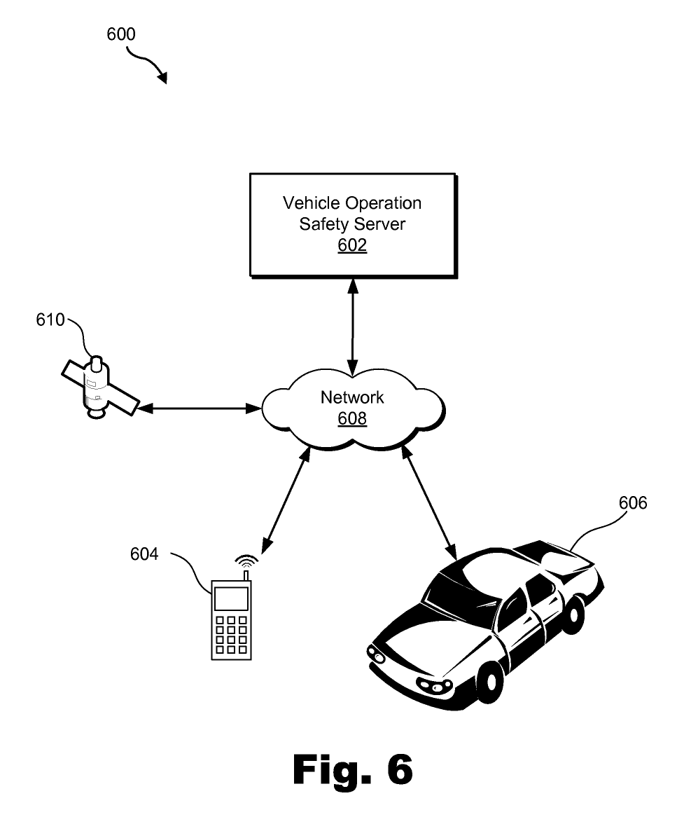

A specific implementation of the systems and methods described herein will now be described in connection with FIG. 6. FIG. 6 illustrates an exemplary implementation 600 in which a vehicle operation safety server 602 (or simply “server 602”) is configured to communicate with a mobile access device 604 and a vehicle 606 over a network 608. As shown, vehicle operation safety server 602 may also communicate with one or more satellites 610 (e.g., to detect the physical locations of mobile access device 604 and/or vehicle 606). Network 608 may include any suitable network or combination of networks configured to facilitate communication between server 602, mobile access device 604, vehicle 606, and/or satellite 610.

Any of facilities 102-108 may be implemented by vehicle operation safety server 602 and/or one or more of access device 604, vehicle 606, and satellite 610. For example, operating parameter detection facility 102 may be implemented by vehicle 606, vicinity detection facility 104 may be implemented by server 602, mobile access device 604, and/or vehicle 606, feature disablement facility 106 may be implemented by mobile access device 604 and/or vehicle 606, and storage facility 108 may be implemented by server 602, mobile access device 604, and/or vehicle 606.

In some examples, any of the components of configuration 600 may be configured to perform any of the steps or processes described herein. For example, any of the components of configuration 600 may be configured to detect an operating parameter of vehicle 606, detect that mobile access device 604 is located within a predefined vicinity of vehicle 606, and/or disable one or more features of mobile access device 604 in response to a detection of the operating parameter of vehicle 606 and the detection that mobile access device 604 is located within a predefined vicinity of vehicle 606.

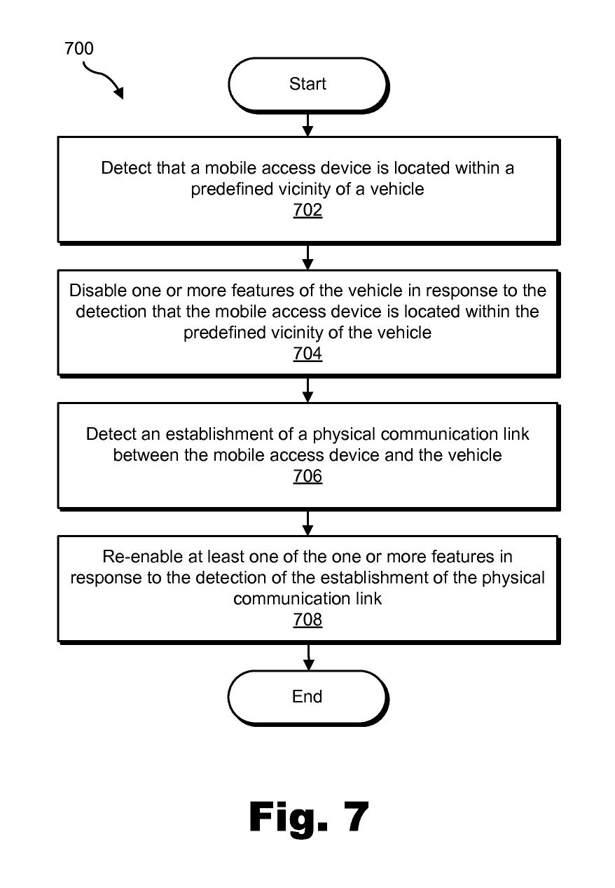

FIG. 7 illustrates another exemplary vehicle operation safety method 700. While FIG. 7 illustrates exemplary steps according to one embodiment, other embodiments may omit, add to, reorder, and/or modify any of the steps shown in FIG. 7. One or more steps shown in FIG. 7 may be performed by any component or combination of components of system 100.

In step 702, system 100 detects that a mobile access device is located within a predefined vicinity of a vehicle. The detection may be performed in any of the ways described herein.

In step 704, one or more features of the vehicle may be disabled in response to the detection that the mobile access device is located within the predefined vicinity of the vehicle. The one or more features of the vehicle may be disabled in any of the ways described herein.

In step 706, an establishment of a physical communication link between the mobile access device and the vehicle may be detected. The establishment of the physical communication link between the mobile access device and the vehicle may be detected in any of the ways described herein.

In step 708, at least one of the one or more features may be re-enabled in response to the detection of the establishment of the physical communication link. Any of the one or more features may be re-enabled in any suitable manner.

In certain embodiments, one or more of the components and/or processes described herein may be implemented and/or performed by one or more appropriately configured computing devices. To this end, one or more of the systems and/or components described above may include or be implemented by any computer hardware and/or computer-implemented instructions (e.g., software) embodied in a non-transitory computer-readable medium, or combinations of computer-implemented instructions and hardware, configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

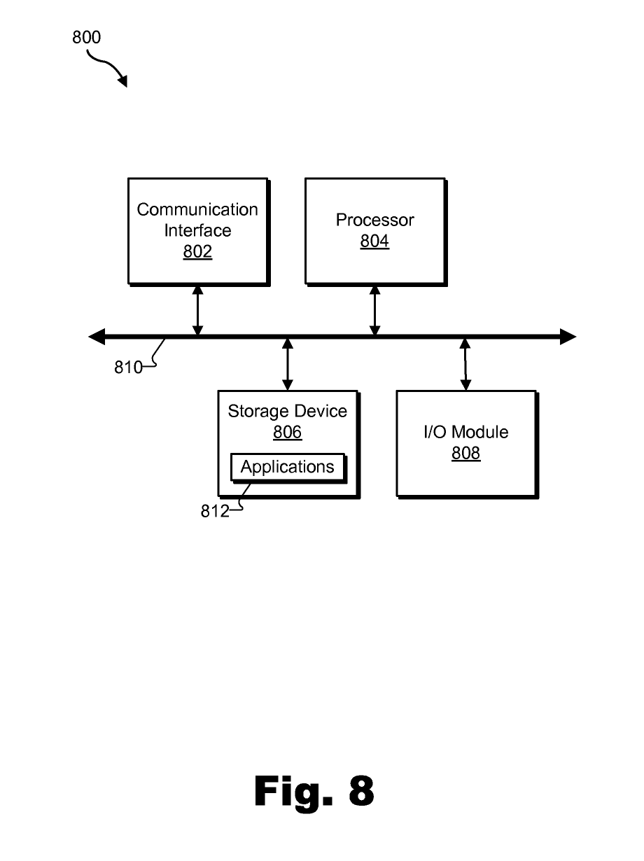

FIG. 8 illustrates an exemplary computing device 800 that may be configured to perform one or more of the processes described herein. As shown in FIG. 8, computing device 800 may include a communication interface 802, a processor 804, a storage device 806, and an input/output (“I/O”) module 808 communicatively connected via a communication infrastructure 810. While an exemplary computing device 800 is shown in FIG. 8, the components illustrated in FIG. 8 are not intended to be limiting. Additional or alternative components may be used in other embodiments. Components of computing device 800 shown in FIG. 8 will now be described in additional detail.

Communication interface 802 may be configured to communicate with one or more computing devices. Examples of communication interface 802 include, without limitation, a wired network interface (such as a network interface card), a wireless network interface (such as a wireless network interface card), a modem, and any other suitable interface. In at least one embodiment, communication interface 802 may provide a direct connection between vehicle computing subsystem 202 and/or mobile access device 204 via a direct link to a network. Communication interface 802 may additionally or alternatively provide such a connection through, for example, a local area network (such as an Ethernet network), a personal area network, a telephone or cable network, a satellite data connection, a dedicated URL, or any other suitable connection. Communication interface 802 may be configured to interface with any suitable communication media, protocols, and formats, including any of those mentioned above.

Processor 804 generally represents any type or form of processing unit capable of processing data or interpreting, executing, and/or directing execution of one or more of the instructions, processes, and/or operations described herein. Processor 804 may direct execution of operations in accordance with one or more applications 812 or other computer-executable instructions such as may be stored in storage device 806 or another computer-readable medium.

Storage device 806 may include one or more data storage media, devices, or configurations and may employ any type, form, and combination of data storage media and/or device. For example, storage device 806 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 806. For example, data representative of one or more executable applications 812 (which may include, but are not limited to, one or more of the software applications described herein) configured to direct processor 804 to perform any of the operations described herein may be stored within storage device 806. In some examples, data may be arranged in one or more databases residing within storage device 806.

I/O module 808 may be configured to receive user input and provide user output and may include any hardware, firmware, software, or combination thereof supportive of input and output capabilities. For example, I/O module 808 may include hardware and/or software for capturing user input, including, but not limited to, a keyboard or keypad, a touch screen component (e.g., touch screen display), a receiver (e.g., an RF or infrared receiver), and/or one or more input buttons.

I/O module 808 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 808 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 800. For example, one or more applications 812 residing within storage device 806 may be configured to direct processor 804 to perform one or more processes or functions associated with operating parameter detection facility 102, vicinity detection facility 104, and/or feature disablement facility 106. Likewise, storage facility 108 may be implemented by or within storage device 806.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
detecting, by a vehicle operation safety system, an operating parameter of a vehicle;
detecting, by the vehicle operation safety system, that a mobile access device is located within a predefined vicinity of the vehicle; and
disabling, by the vehicle operation safety system, one or more features of the mobile access device in response to the detecting of the operating parameter of the vehicle and the detecting that the mobile access device is located within the predefined vicinity of the vehicle.

2. The method of claim 1, wherein the detecting of the operating parameter of the vehicle comprises detecting that a transmission of the vehicle is in gear.

3. The method of claim 1, wherein the detecting of the operating parameter of the vehicle comprises detecting movement of the vehicle.

4. The method of claim 1, wherein the detecting that the mobile access device is within the predefined vicinity of the vehicle comprises detecting, by the vehicle operation safety system, a Bluetooth signal transmitted between the mobile access device and the vehicle.

5. The method of claim 1, wherein the one or more features of the mobile access device that are disabled comprise a text-messaging feature of the mobile access device.

6. The method of claim 5, further comprising:
detecting, by the vehicle operation safety system, an incoming text message; and
transmitting, by the vehicle operation safety system, an automated response to a sender of the text message, the automated response indicating that a user of the mobile access device is unavailable.

7. The method of claim 5, further comprising:
detecting, by the vehicle operation safety system, an enabling of a hands-free texting feature of the mobile access device; and
re-enabling, by the vehicle operation safety system, the text-messaging feature of the mobile access device in response to the enabling of the hands-free texting feature of the mobile access device.

8. The method of claim 7, wherein the hands-free texting feature comprises at least one of a speech-to-text feature and a text-to-speech feature of the mobile access device.

9. The method of claim 1, wherein the one or more features of the mobile access device that are disabled comprise a calling feature of the mobile access device.

10. The method of claim 9, further comprising:
detecting, by the vehicle operation safety system, an enabling of a hands-free calling feature of the mobile access device; and
re-enabling, by the vehicle operation safety system, the calling feature of the mobile access device in response to the enabling of the hands-free calling feature of the mobile access device.

11. The method of claim 10, wherein the detecting of the enabling of the hands-free calling feature of the mobile access device comprises detecting a docking of the mobile access device in a docking station associated with the vehicle.

12. The method of claim 1, wherein the detecting that the mobile access device is located within the predefined vicinity of the vehicle comprises:
detecting, by the vehicle operation safety system, a physical location of the vehicle;
detecting, by the vehicle operation safety system, a physical location of the mobile access device; and
determining, by the vehicle operation safety system, that the physical location of the mobile access device is within the predefined vicinity of the physical location of the vehicle.

13. The method of claim 12, wherein the detecting of the physical location of the vehicle comprises detecting a global positioning satellite (“GPS”) position of the vehicle and the detecting of the physical location of the mobile access device comprises detecting a GPS position of the mobile access device.

14. The method of claim 1, embodied as computer-executable instructions on at least one non-transitory computer-readable medium.

15. A method comprising:
detecting, by a vehicle operation safety system, that a mobile access device is located within a predefined vicinity of a vehicle;
disabling, by the vehicle operation safety system, one or more features of the vehicle in response to the detecting that the mobile access device is located within the predefined vicinity;
detecting, by the vehicle operation safety system, an establishment of a physical communication link between the mobile access device and the vehicle; and
re-enabling, by the vehicle operation safety system, at least one of the one or more features of the vehicle in response to the establishment of the physical communication link.

16. The method of claim 15, wherein the establishment of the physical communication link comprises a docking of the mobile access device into a docking station associated with the vehicle.

17. The method of claim 15, further comprising:
detecting, by the vehicle operation safety system, an operating parameter of the vehicle after the establishment of the physical communication link between the mobile access device and the vehicle; and
disabling, by the vehicle operation safety system, one or more features of the mobile access device in response to the detecting of the operating parameter of the vehicle.

18. The method of claim 15, further comprising enabling, by the vehicle operation safety system, a hands-free calling feature of the mobile access device in response to the establishment of the physical communication link.

19. The method of claim 15, wherein the disabling of the one or more features of the vehicle comprises disabling an ignition of the vehicle.

20. A system comprising:
an operating parameter detection facility configured to detect an operating parameter of a vehicle;
a vicinity detection facility communicatively coupled to the operating parameter facility and configured to detect that a mobile access device is located within a predefined vicinity of the vehicle; and
a feature disablement facility communicatively coupled to the vicinity detection facility and the operating parameter detection facility and configured to disable one or more features of the mobile access device in response to a detection, by the operating parameter detection facility, of the operating parameter of the vehicle and a detection, by the vicinity detection facility, that the mobile access device is located within the predefined vicinity of the vehicle.

21. The system of claim 20, wherein the feature disablement facility is further configured to selectively re-enable at least one of the one or more features of the mobile access device in response to a detection that a hands-free feature of the mobile access device has been enabled.
